(19) United States
(12) Patent Application Publication
(10) Pub. No.: US 2025/0096643 A1
(43) Pub. Date: Mar. 20, 2025

(54) A SYSTEM FOR GENERATING ELECTRICITY

(71) Applicant: Amit Kumar BAYEN, Bijoynagar (IN)

(72) Inventor: Amit Kumar BAYEN, Bijoynagar (IN)

(21) Appl. No.: 18/702,512

(22) PCT Filed: May 6, 2023
(86) PCT No.: PCT/IN2023/050438

§ 371 Date: Apr. 18, 2024

(30) Foreign Application Priority Data
Jun. 4, 2022 (IN) 202231032032

(51) Int. Cl. H02K 7/18; F03G 5/04; F16H 55/17; H02K 7/116

(52) U.S. Cl. CPC H02K 7/1861; F03G 5/04; F16H 55/17; H02K 7/116

(57) ABSTRACT

This invention relates to a system for generating electricity and in particular, this invention relates to a system for generating electricity wherein jokey or operator will control the animals. This invention relates to a system for generating electricity wherein Generator will be run by animals muscle power to produce electricity. Furthermore, this invention also relates to a system for generating electricity which has the beneficial effects of having saving manpower cost. reducing labor intensity. and having safety and reliability and the transportation economic benefits can be increased.

### FIELD OF THE INVENTION

This invention relates to a system for generating electricity and in particular, this invention relates to a system for generating electricity wherein jokey or operator will control the animals. This invention relates to a system for generating electricity wherein Generator will be run by animals muscle power to produce electricity. Furthermore, this invention also relates to a system for generating electricity which has the beneficial effects of having saving manpower cost, reducing labor intensity, and having safety and reliability and the transportation economic benefits can be increased.

### BACKGROUND OF THE INVENTION AND THE RELATED PRIOR ART

Continuous consumption of energy (for example, gasoline) causes shortage of natural resources. In order to satisfy the demand for energy, different power generating methods have been developed. These power generating methods use nuclear power, thermal power, hydraulic power, wind power, sun energy, or sea wave power to rotate a rotor, to further cause a magnetic induction. The revolving speed determines the output of the power generating system. The faster the revolving speed of the rotor is, the more the output of the power generating system will be. Therefore, for generating electricity, energy (force) is needed to rotate the rotor of the power generating system.

The patent document US2022141996 describes systems and methods for heat exchange and cooling for a sensor enclosure on a vehicle, for example, a LiDAR sensor enclosure mounted on a roof of an AV, that are more convenient and reduce a computational burden on the sensor system, such as an AV sensor system. Various embodiments of the present disclosure provide a heat exchange system disposed on a vehicle. The heat exchange system may comprise an enclosure disposed on the vehicle. The enclosure may comprise a vent at a base of the enclosure, a fan disposed at a base of the enclosure, and one or more sensors within the enclosure. The heat exchange system may comprise a deflector disposed on the vehicle outside the enclosure and configured to direct an airflow into the vent of the enclosure. The heat exchange system may comprise a motor configured to generate electricity from the airflow and selectively supply electricity to operate the fan. The heat exchange system may comprise a controller configured to adjust the deflector and regulate an amount of electricity supplied from the motor to the fan.

The other document CA3149733 discloses an electricity supply system includes: an engine:

an electricity generator that generates electricity using drive power of the engine: an electricity accumulator that accumulates at least one of electricity generated by the electricity generator and regenerative electricity coming from an electrical load: an electricity feeder that supplies the electricity accumulated in the electricity accumulator and the electricity generated by the electricity generator to the electrical load: and a controller.

The controller measures an SOC of the electricity accumulator, derives an average SOC level from the SOC, determines an electricity generator target output level based on the average SOC level, and controls an output of the electricity generator to the electricity generator target output level. The electricity generator target output level is set to a standard value higher than zero in case that the average SOC level is higher than a predetermined maximum allowable value. The electricity generator target output level is set to a correction value higher than the standard value in case that the average SOC level is lower than a predetermined minimum allowable value. The electricity generator target output level is kept at a currently set value in case that the average SOC level is equal to or higher than the minimum allowable value and equal to or lower than the maximum allowable value.

According to the document US2022106939 describes a system for producing electricity from wind energy is provided. The system comprises a balloon configured for inflation with a buoyant gas. The system further comprises at least one turbine-generator system coupled to the balloon, comprising a turbine and generator. The turbine is configured to rotate when subjected to an external airflow. The generator is coupled to the turbine and is configured to convert rotation of the turbine into electricity. The system further comprises an electrical storage system for storing the generated electricity.

The document WO2022060326 relates to a system comprising a power generator which provides solvent passage from one of the liquids to the other liquid by means of an osmotic membrane provided between liquids taken to a first volume and to a second volume and having different densities and which provides increasing of the pressure of the liquid to which the solvent passage occurs and which provides generation of electricity from the formed pressure. Accordingly, the subject matter system comprises a first regeneration unit and a second regeneration unit embodied to provide equalization of the vapor pressure of the liquid accommodated therein to the vapor pressure of air: a retaining chamber hydraulically connected to the second regeneration unit in order to transfer the liquid obtained by the second regeneration unit by time: a valve unit which operates in a first operation mode (I) where said first regeneration unit and the first volume of the power generator are hydraulically connected and the retaining chamber and the second volume of the power generator are hydraulically connected selectively and in a second operation mode (II) where the first regeneration unit and the second volume of the power generator are hydraulically connected and the retaining chamber and the first volume of the power generator are hydraulically connected: a first density sensor provided between the first regeneration unit and the valve unit, a second density sensor provided between the retaining chamber and the valve unit: a control unit configured to take the measurements made by said first density sensor and said second density sensor and to control operation of the valve unit: and said control unit is configured to determine the liquid having high density in accordance with the measurements taken and to determine the operation mode of the valve unit accordingly.

According to the invention US2013099506 provides an electricity generation device capable of generating electricity using kinetic energy generated by spontaneous behavior of an animal. The device includes a mechano-electric conversion mechanism that converts a displacement of a body part where the animal spontaneously moves (for example, a mouth) into an electric energy. For example, the mechano-electric conversion mechanism can have an arrangement for converting the displacement of the body part into rotation by a combination of a rack and a gear and rotating the rotor of a dynamo or an alternator.

This invention belongs to the power generating system. The system enhances output, in which a motor of about 700 W to 750 W produces horsepower to rotate a power generating unit, causing the power generating unit to produce electricity, and a transmission device is coupled between the motor and the power generating unit to increase the horsepower of the motor to the power generating unit two to three times by the application of inertia force and lever force which has been stated in document of patent application U.S. Pat. No. 6,433,450.

The document U.S. Pat. No. 3,374,376 describes a generator of such construction that its reaction torque and, therefore, its rotor speed in response to a given driving torque varies but little upon changeover from open circuit to current delivery or vice versa.

None of these above patents, however alone or in combination, disclose the present invention. The invention consists of certain novel features and a combination of parts hereinafter fully described, illustrated in the accompanying drawings, and particularly pointed out in the appended claims, it being understood that various changes in the details may be made without departing from the spirit, or sacrificing any of the advantages of the present invention.

### SUMMARY OF THE INVENTION

This invention relates to a system for generating electricity and in particular, this invention relates to a system for generating electricity wherein jokey or operator will control the animals. This invention relates to a system for generating electricity wherein Generator will be run by animals muscle power to produce electricity. Furthermore, this invention also relates to a system for generating electricity which has the beneficial effects of having saving manpower cost, reducing labor intensity, and having safety and reliability and the transportation economic benefits can be increased.

### DETAILED DESCRIPTION OF THE INVENTION WITH ACCOMPANYING DRAWINGS

For the purpose of facilitating an understanding of the invention, there is illustrated in the accompanying drawings a preferred embodiment thereof, from an inspection of which, when considered in connection with the following description, the invention, its construction and operation, and many of its advantages should be readily understood and appreciated. The drawings are in eight sheets.

The principal object of the invention is to provide a system for generating electricity.

The other embodiment of the invention is to provide a system for generating electricity which consists of
having a six identical power units (14.1-14.6) wherein metal rod and big gear along with each power unit should be firmly rested on the metal rail top:
wherein the five rails situated at the top of the walls which is constructed with brick, sand: cement, stone, and with metal rail top:
wherein the three bar or blades (3.1,3.2, 3.3) connected at the bottom of this ring gear are situated at the top of the rails:
wherein Seven gears are arranged sequentially inside the seven meters ring gear (2);
wherein the main shaft (7.1) rotates very fast that is attached with the generator which is connected with converter and transformer:

The other embodiment of the invention is to provide a system for generating electricity wherein length of the bar or blades are 50 meters.

The other embodiment of the invention is to provide a system for generating electricity wherein the first gear (4) having a diameter of 60 cm are provided with bearing in the middle portion and they look like free wheels.

The other embodiment of the invention is to provide a system for generating electricity wherein Four gear (4.1, 4.2, 4.3, 4,4) are double spur gears.

The other embodiment of the invention is to provide a system for generating electricity wherein spur gear (5) of 30 cm diameter has attached with spur gear (7).

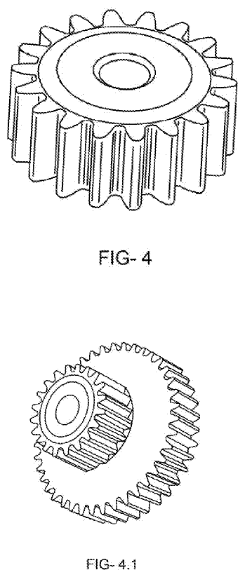

The other embodiment of the invention is to provide a system for generating electricity wherein one time revolve of animals (horses) rotates ring gear (2) once which rotates the spur gear (4) 11.5 times and as a result (4.1) double spur gear will rotate 23 times and (FIG. 4.2) double spur gear rotation 69 times.

The other embodiment of the invention is to provide a system for generating electricity wherein in double spur gear ratio of big gear diameter 90 cm and small gear diameter is 3:1.

The other embodiment of the invention is to provide a system for generating electricity wherein in double spur gear the diameter of big gear is 90 cm.

The other embodiment of the invention is to provide a system for generating electricity wherein in double spur gear the diameter of small gear is 30 cm. The other embodiment of the invention is to provide a system for generating electricity further comprises a processing unit (17.1) a memory (17.2), an input/output interface (17.3) and a display unit (17.4). The processing unit 17.1 is configured to receive, Via the I/O interface (17.3), inputs for controlling the power generation system.

In another embodiment, the power generation system may be integrated with software application that is capable of receiving the inputs for controlling the power generation system and controlling and distributing the power generated in the power generation system.

The novel features that are considered characteristic of the present invention are set forth with particularity in the appended claims. The invention itself, however, both as to its organization and its method of operation, together with additional objects and advantages thereof, will best be understood from the following description of certain specific embodiments, when read in connection with the accompanying drawings, in which:

The FIG. 1 shows according to the invention;

The FIG. (1.1, to 1.5) shows rails according to the invention;

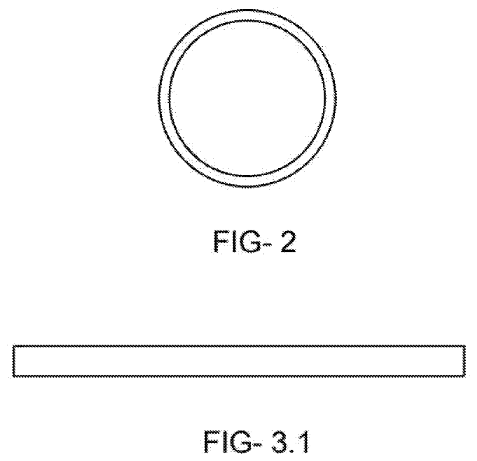

The FIG. 2 shows ring gear according to the invention:

The FIG. 3.1 to 3.3 shows 50-meter length bar according to the invention:

The FIG. 4 shows spur gear having a diameter 60 cm according to the invention:

The FIG. (4.1 to 4.4) shows double spur gear having same size according to the invention:

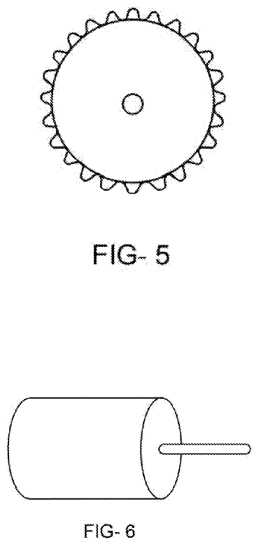

The FIG. 5 shows spur gear having a diameter of 30 cm according to the invention;

The FIG. 6 shows a generator according to the invention;

The FIG. 7 shows a spur gear according to the invention:

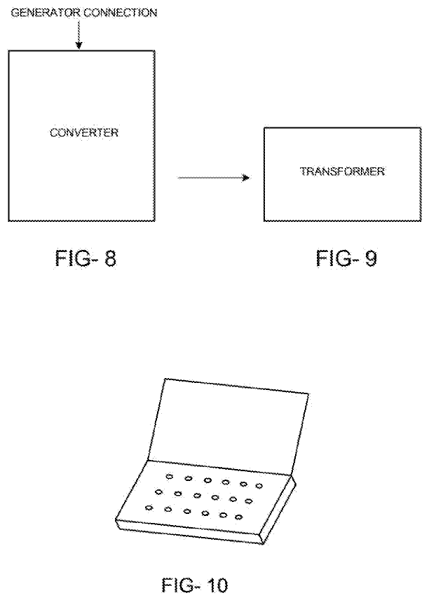

The FIG. 8 shows a converter according to the invention:

The FIG. 9 shows a transformer according to the invention;

The FIG. 10 shows a digital monitoring system according to the invention;

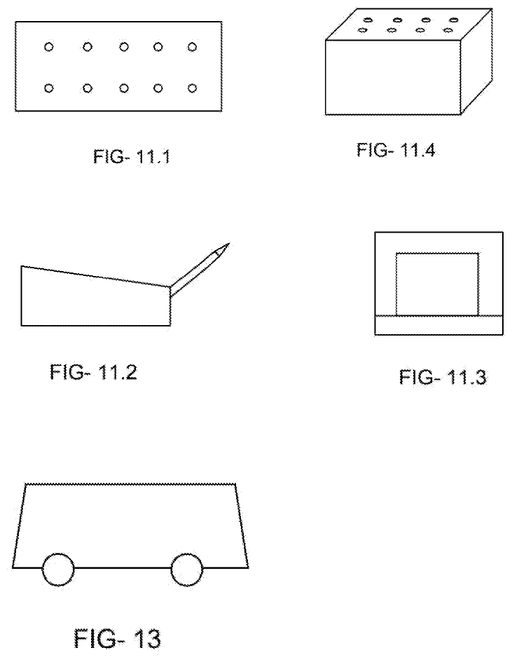

The FIG. 11 shows Remote Control System according to the invention;

The FIG. 11.′1 shows a remote control according to the invention;

The FIG. 11.2 shows a Receiver according to the invention:

The FIG. 11.3 shows a battery charger according to the invention;

The FIG. 11.4 shows a battery according to the invention;

The FIG. 11.5 shows a loud speaker according to the invention;

The FIG. 11.6 shows a 3 volt transformer for electric shock according to the invention:

The FIG. 11,7 shows a magnetic system according to the invention;

The FIG. 12 shows animals according to the invention:

The FIG. 13 shows a Diesel engine according to the invention:

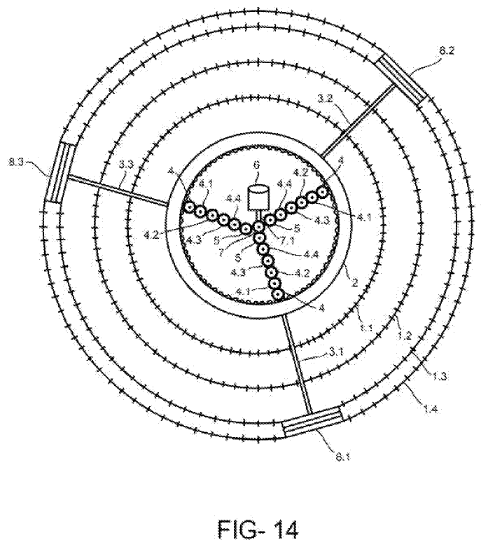

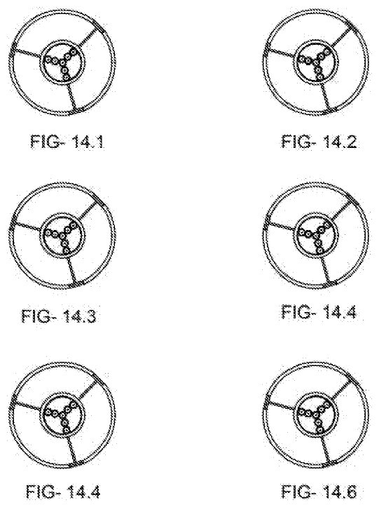

The FIG. 14 shows according to the invention:

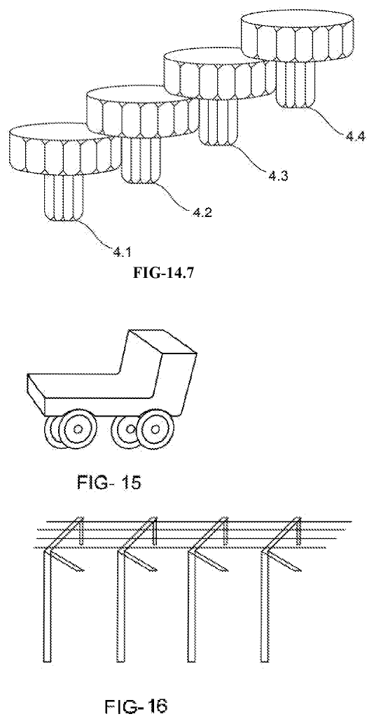

The FIG. 15 shows according to the invention:

The FIG. 16 shows a conductor according to the invention:

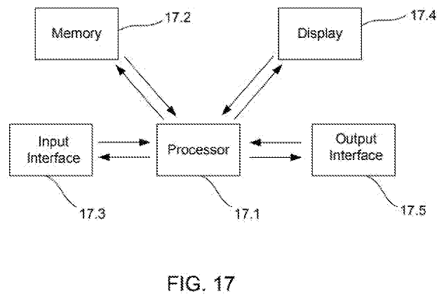

The FIG. 17 shows a depicts the computer system comprising processing unit (17.1) memory (17.2) input/output interface (17.3) and display units (17.4)

The system according to the invention comprises of specific gears, generator, converter, transformer, diesel engine. The generator is run with animal's (cow, horse, donkey) muscle power or body strength. A piece of land of about 10000 square meter piece is required. The horses move in a circular way at the end of bar or blades (please see the drawing FIG. 14.1). Animal will be trained Jokey will control the animals from three wheeled desk. All generating system will perform on the rail. Diesel engine will perform on the rail in absent of animals.

There are five rails (FIG. 1.1, to 1.5) at the top of the walls. This wall is constructed with brick, sand: cement, stone, with metal rail top. Wall height is 4 feet. There are three bar or blades (3.1,3.2, 3.3) at the top of the rails.

The length of the bar or blades 50 meter. A ring gear (2) in the center of 7-meter diameter length. At the bottom of this ring gear has connected with the blades. Has a spur gear of diameter 60 cm (4), inside of the ring gear (2), this gear also works as a free gear.

The system has six identical power units (14.1-14.6) as shown in FIG. 14. Each unit has a roundel shaped, big gear (2) having diameter of seven meter and three metal rods (3.1, 3.2, 3.3) of 50 meters length are fixed with the gear. The whole arrangement should be firmly rested on the metal rail top.

Seven gears are arranged sequentially inside the seven meters ring gear (2).

The first gear (4) having a diameter of 60 cm. are provided with bearing in the middle portion and they look like free wheels. This is because if any of the animals (cow, horse, donkey) to rotate or rotates slowly this will not hamper the efficiency of the whole system. Four gear are same (4.1, 4.2, 4.3, 4,4) and also are double spur gears (4.1) and works for low speed to high speed. The spur gear (5) of 30 cm diameter has attached with spur gear (7).

This main shaft (7.1) rotates very fast, a generator is attached with this main shaft (7.1). The generator is connected with converter and transformer.

Two animals (cow, horse, donkey) are attached with three wheeled desks (15.1) shown in FIG. 15. The desk is attached at one end of the 50 m rod (3.1, 3.2,3.3). An operator will control motion and direction of the animals, like horses will be controlled with three reins.

These reins are fixed with horse's bits. These bits are present on both side of horse's ears.

The system can be controlled with the help of remote control from a distance of 60 meter. Only for sound stimulation can be used loudspeaker by the remote control. A magnetic system works to goes forward. This magnetic system works like an electrical bell, but bell hummer is made by soft rubber for soft hit at the animal's back.

In absent of animals a diesel engine will perform to product the electricity. The desk is pulled by the animals. The desk is joined with the part of a 50 m long rod, while rotating in a circular way, a ring gear (2) is also rotating. The gears (4,4.1, 4.2,4.3,4.4, 5,7) start rotating simultaneously. The main shaft also rotates. The generator is attached with the shaft. The generator is connected with the convertor (8) and transformer (9) for delivering of electricity to the power transmission conductors.

The 50 m long bar (3.1,3.2, 3.3,) may be compared with a first-class lever. First class lever has fulcrum in the middle resistance and effort on the two sides; a first-class lever is used for lifting heavy objects with a small force acting on it. The disadvantage of the first-class lever is the fulcrum lies on more efforts or more force.

All gears should have bearing except big gear (2) having a diameter of seven meter. There are total six power units in the invention. Each unit requires six animals (COW, HORSE, p DONKEY) for operation. However, the number of animals can be increased or dropped according to the need of the power. Every power unit has the same 90 volt M.W, generator. In total 30 M.W. current is produced from 36 horses or 48 cows.

With refer to FIG. 14.1 wherein FIG. (3.1, 3.2, 3.3) shows 50 m. long rod which is placed on the rail by the help of wheel. All rail are placed on the walls () A gear of diameter 7 m. and three rods of 50 m. is placed on the rails by the help of wheel.

FIG. 2 shows 7 m. gear having teeth in inner side and FIG. 4 is a spur gear of diameter 60 cm. FIG. (4.1-4.4) are double spur gear having ratio is 3:1 big gear diameter 90 cm and small gear diameter 30 cm similar in size.

FIG. 5 is a spur gear having a diameter of 30 cm FIG. 6 is a 90 volt and 5 M.W. generator.

FIG. 7 is a spur gear of diameter 40 cm. has fixed with main shaft (7.1)

FIG. 8 is a converter and FIG. 9 is a transformer and FIG. 10 Digital Monitoring system:

FIG. 11 shows Remote Control system and this system offers long distance control for control of diesel engine and also animal movement. FIG. 12 is animals. like cows, horses, donkeys etc. FIG. 13 is a diesel engine, will perform in absent of animals. FIG. 14 is power units. there are six power units. FIG. 15 is three-wheeler.

### Total Rotation Measurement is Given Following Below:

Animals (horses) one time revolve meaning ring gear (2) rotates once, the spur gear (4) will rotate 11.5 times. As a result (4.1) double spur gear will rotate 23 times and FIG. 4.2 double spur gear rotation 69 times.

FIG. 4.3 double spur gear rotation 207 times.

FIG. 4.4 double spur gear rotation 621 times.

FIG. 5 spur gear rotation 1863 times.

FIG. 7 spur gear rotation 1400 times.

Without further elaboration, the foregoing will so fully illustrate my invention, that others may, by applying current of future knowledge, readily adapt the same for use under various conditions of service. It should also be realized by those skilled in the art that such equivalent constructions do not depart from the spirit and scope of the invention.

### Advantages Over the Prior Art

The system for generating electricity proposed by the present invention has the following advantages over the prior art:
a) It is cost effective as compared to others machine available in the market.
b) It greatly facilitates the discharge operation, and also effectively improves the discharge efficiency.
c) It has the characteristics of simple structure, convenient use, high efficiency.
d) It is economical in maintenances.
e) The power generation system is configured such that if any animal stop movement or moves slowly.
f) The working and the efficiency of the whole system will not be hampered.

In the preceding specification, the invention has been described with reference to specific exemplary embodiments thereof. It will be evident that various modifications and changes may be made thereunto without departing from the broader spirit and scope of the invention as set forth in the claims that follow. The specification and drawings are accordingly to be regarded in an illustrative rather than restrictive sense. Therefore, the aim in the appended claims is to cover all such changes and modifications as fall within the true spirit and scope of the invention. The matter set forth in the foregoing description and accompanying drawings is offered by way of illustration only and not as a limitation. The actual scope of the invention is intended to be defined in the following claims when viewed in their proper perspective based on the prior art.

1. A system for generating electricity which consists of
having a six identical power units (14.1-14.6) wherein metal rod and big gear along with each power unit should be firmly rested on the metal rail top:
wherein the five-rail situated at the top of the walls which is constructed with brick, sand; cement, stone, and with metal rail top;
wherein the three bar or blades (3.1,3.2, 3.3) connected at the bottom of this ring gear are situated at the top of the rails;
wherein Seven gears are arranged sequentially inside the seven-meter ring gear (2);
wherein the main shaft (7.1) rotates very fast that is attached with the generator which is connected with converter and transformer;
Characterized in that the processing unit (17.1) a memory (17.2), an input/output interface (17.3) and a display unit (17.4).

2. The system for generating electricity as claimed in claim 1 wherein length of the bar or blades is 50 meters.

3. The system for generating electricity as claimed in claim 1 wherein the first gear (4) having a diameter of 60 cm are provided with bearing in the middle portion and they look like free wheels.

4. The system for generating electricity as claimed in claim 1 wherein four gear (4.1, 4.2, 4.3, 4,4) are double spur gears.

5. The system for generating electricity as claimed in claim 1 wherein spur gear (5) of 30 cm diameter has attached with spur gear (7).

6. The system for generating electricity as claimed in claim 1 wherein one time revolve of animals (horses) rotates ring gear (2) once which rotates the spur gear (4) 11.5 times and as a result (4.1) double spur gear will rotate 23 times and (FIG. 4.2) double spur gear rotation 69 times.

7. The system for generating electricity as claimed in claim 1 wherein in double spur gear ratio of big gear diameter 90 cm and small gear diameter is 3:1.

8. The system for generating electricity as claimed in claim 1 wherein in double spur gear the diameter of big gear is 90 cm.

9. The system for generating electricity as claimed in claim 1 wherein in double spur gear the diameter of small gear is 30 cm.

10. The system for generating electricity as claimed in claim 1 wherein the processing unit 17.1 is configured to receive, via the I/O interface (17.3), inputs for controlling the power generation system.
